(19) United States
(12) Patent Application Publication
(10) Pub. No.: US 2026/0122620 A1
(43) Pub. Date: Apr. 30, 2026

(54) WIRELESS COMMUNICATION METHOD AND APPARATUS

(71) Applicant: QUECTEL WIRELESS SOLUTIONS CO., LTD., Shanghai (CN)

(72) Inventors: Ling LYU, Frisco, TX (US); Zheng ZHAO, Shanghai (CN)

(21) Appl. No.: 19/432,627

(22) Filed: Dec. 24, 2025

Related U.S. Application Data
(63) Continuation of application No. PCT/CN2024/099379, filed on Jun. 14, 2024.

(51) Int. Cl. H04W 72/0446; H04W 56/00; H04W 84/06

(52) U.S. Cl. CPC H04W 72/0446; H04W 56/0045; H04W 84/06

(57) ABSTRACT

A wireless communication method and apparatus are provided. One example method includes: sending, by a first device, a first TAR according to first information. The first information includes a service serving time of the first device and/or a service type of the first device.

### CROSS-REFERENCE TO RELATED APPLICATIONS

This application is a continuation of International Application No. PCT/CN2024/099379, filed on Jun. 14, 2024, the disclosure of which is hereby incorporated by reference in its entirety.

### TECHNICAL FIELD

This application relates to the field of communications technologies, and more specifically, to a wireless communication method and apparatus.

### BACKGROUND

Some communications systems (e.g., non-terrestrial network (non-terrestrial network, NTN) systems) have large transmission delays. In these communications systems, if a communications device performs communication in a half-duplex mode, an uplink transmission of the communications device may conflict with downlink reception, or may conflict with another uplink transmission. Therefore, in these communications systems, how to resolve a transmission conflict in the half-duplex mode becomes a technical problem to be resolved.

### SUMMARY

This application provides a wireless communication method and apparatus. The following describes the aspects involved in the embodiments of this application.

According to a first aspect, a wireless communication method is provided, including: sending, by a first device, a first timing advance report (timing advance report, TAR) according to first information. The first information includes a service serving time of the first device and/or a service type of the first device.

According to a second aspect, a wireless communication method is provided, including: receiving, by a second device, a first TAR sent by a first device. The first TAR is triggered according to first information, where the first information includes a service serving time of the first device and/or a service type of the first device.

According to a third aspect, a wireless communication apparatus is provided, where the apparatus is a first device, and the first device includes a first transceiver unit sending a first TAR according to first information. The first information includes a service serving time of the first device and/or a service type of the first device.

According to a fourth aspect, a wireless communication apparatus is provided, where the apparatus is a second device, and the second device includes a second transceiver unit, receiving a first TAR sent by a first device. The first TAR is triggered according to first information, where the first information includes a service serving time of the first device and/or a service type of the first device.

According to a fifth aspect, a communications apparatus is provided, including a memory and a processor, where the memory is configured to store a program, and the processor is configured to invoke the program in the memory to execute the method according to the first aspect or the second aspect.

According to a sixth aspect, an apparatus is provided, including a processor, configured to invoke a program from a memory to execute the method according to the first aspect or the second aspect.

According to a seventh aspect, a chip is provided, including a processor, configured to invoke a program from a memory, to cause a device installed with the chip to perform the method according to the first aspect or the second aspect.

According to an eighth aspect, a computer readable storage medium is provided, where a program is stored thereon, and the program causes a computer to execute the method according to the first aspect or the second aspect.

According to a ninth aspect, a computer program product is provided, including a program that causes a computer to execute the method according to the first aspect or the second aspect.

According to a tenth aspect, a computer program is provided, where the computer program causes the computer to execute the method according to the first aspect or the second aspect.

In embodiments of the application, the first device sends the first TAR according to a service serving time and/or a service type of the first device. Compared with a method for triggering a first TAR according to a higher layer configuration, the method implements a finer TAR reporting granularity by adding an event for triggering the first TAR, which helps reduce transmission conflicts and reduce a ratio of unavailable resources.

### BRIEF DESCRIPTION OF DRAWINGS

FIG. 1 is a wireless communications system applied in an embodiment of this application.

FIG. 2 is an NTN system applying an embodiment of this application.

FIG. 3 is another NTN system applying an embodiment of this application.

FIG. 4 is a schematic diagram of a conflict between a downlink transmission and an uplink transmission.

FIG. 5 is a schematic diagram of a timing advance change of a serving cell in an NTN system.

FIG. 6 is a schematic flowchart of a wireless communication method according to an embodiment of this application.

FIG. 7 is a schematic flowchart of another wireless communication method according to an embodiment of this application.

FIG. 8 is a schematic diagram of a possible implementation manner of the method shown in FIG. 7.

FIG. 9 is a schematic diagram of another possible implementation manner of the method shown in FIG. 7.

FIG. 10 is a schematic diagram of still another possible implementation manner of the method shown in FIG. 7.

FIG. 11 is a schematic structural diagram of a wireless communication apparatus according to an embodiment of this application.

FIG. 12 is a schematic structural diagram of another wireless communication apparatus according to an embodiment of this application.

FIG. 13 is a schematic structural diagram of still another wireless communication apparatus according to an embodiment of this application.

FIG. 14 is a schematic structural diagram of still another wireless communication apparatus according to an embodiment of this application.

FIG. 15 is a schematic structural diagram of a communications apparatus according to an embodiment of this application.

### DESCRIPTION OF EMBODIMENTS

The following describes the technical solutions in the embodiments of this application with reference to the accompanying drawings in the embodiments of this application. Apparently, the described embodiments are some rather than all of the embodiments of this application. For the embodiments of this application, all other embodiments obtained by a person of ordinary skill in the art without creative efforts fall within the protection scope of this application.

Embodiments of the application may be applied to various communications systems. For example, the embodiments of this application may be applied to a global system of mobile communication (global system of mobile communication, GSM) system, a code division multiple access (code division multiple access, CDMA) system, a wideband code division multiple access (wideband code division multiple access, WCDMA) system, a general packet radio service (general packet radio service, GPRS), a long term evolution (long term evolution, LTE) system, an advanced long term evolution (advanced long term evolution, LTE-A) system, a new radio (new radio, NR) system, an evolved system of an NR system, an LTE-based access to unlicensed spectrum (LTE-based access to unlicensed spectrum, LTE-U) system, an NR-based access to unlicensed spectrum (NR-based access to unlicensed spectrum, NR-U) system, a universal mobile telecommunication system (universal mobile telecommunication system, UMTS) system, a wireless local area network (wireless local area networks, WLAN), a wireless fidelity (wireless fidelity, WiFi), and a fifth generation communications (5th-generation, 5G) system. Embodiments of the application may be further applied to another communications system, such as a future communications system. The future communications system may be, for example, a sixth generation (6th-generation, 6G) mobile communications system, or a satellite (satellite) communications system.

A quantity of connections supported by a conventional communications system is limited, and is also easy to implement. However, with development of communications technologies, a communications system can support not only conventional cellular communications but also one or more other types of communications. For example, the communications system may support one or more of the following communications: Device-to-device (device to device, D2D) communications, machine to machine (machine to machine, M2M) communications, machine type communication (machine type communication, MTC), enhanced MTC (enhanced MTC, eMTC), vehicle to vehicle (vehicle to vehicle, V2V) communications, and vehicle to everything (vehicle to everything, V2X) communications. Embodiments of the application may also be applied to a communications system that supports the foregoing communications manner.

The communications system in embodiments of this application may be applied to a carrier aggregation (carrier aggregation, CA) scenario, a dual connectivity (dual connectivity, DC) scenario, or a standalone (standalone, SA) networking scenario.

The communications system in embodiments of the application may be applied to an unlicensed spectrum. The unlicensed spectrum may also be considered as a shared spectrum. Alternatively, the communications system in embodiments of the application may be applied to a licensed spectrum. The licensed spectrum may also be considered as a dedicated spectrum.

Embodiments of this application may be applied to an NTN system. As an example, the NTN system may be a 4G-based NTN system, may be a NR-based NTN system, or may be an internet of things (internet of things, IoT) based NTN system or a narrow band internet of things (narrow band internet of things, NB-IoT) based NTN system.

The communications system may include one or more terminal devices. The terminal device mentioned in embodiments of the application may also be referred to as user equipment (user equipment, UE), an access terminal, a user unit, a user station, a mobile station, a mobile station (mobile station, MS), a mobile terminal (mobile Terminal, MT), a remote station, a remote terminal, a mobile device, a user terminal, a terminal, a wireless communications device, a user agent, or a user apparatus.

In some embodiments, the terminal device may be a station (STATION, ST) in the WLAN. In some embodiments, the terminal device may be a cellular phone, a cordless phone, a session initiation protocol (session initiation protocol, SIP) phone, a wireless local loop (wireless local loop, WLL) station, a personal digital assistant (personal digital assistant, PDA) device, a handheld device with a wireless communication function, a computing device or another processing device connected to a wireless modem, an in-vehicle device, a wearable device, a terminal device in a next-generation communications system (such as an NR system), or a terminal device in a future evolved public land mobile network (public land mobile network, PLMN) network.

In some embodiments, the terminal device may be a device that provides voice and/or data connectivity to a user. For example, the terminal device may be a handheld device, an in-vehicle device, or the like that has a wireless connection function. In some specific examples, the terminal device may be a mobile phone (mobile phone), a Pad (Pad), a notebook computer, a laptop computer, a mobile internet device (mobile internet device, MID), a wearable device, a virtual reality (virtual reality, VR) device, an augmented reality (augmented reality, AR) device, a wireless terminal in industrial control (industrial control), a wireless terminal of self driving (self driving), a wireless terminal in a remote medical surgery (remote medical surgery), a wireless terminal in a smart grid (smart grid), a wireless terminal in a transportation safety (transportation safety) system, a wireless terminal in a smart city (smart city), a wireless terminal in a smart home (smart home), or the like.

In some embodiments, the terminal device may be deployed on land. For example, the terminal device may be deployed indoors or outdoors. In some embodiments, the terminal device may be deployed on water, such as on a ship. In some embodiments, terminal devices may be deployed in the air, such as on aircraft, balloons and satellites.

In addition to the terminal device, the communications system may further include one or more network devices. The network device in embodiments of the application may be a device used to communicate with a terminal device, and the network device may also be referred to as an access network device or a radio access network device. The network device may be, for example, a base station. The network device in embodiments of this application may be a radio access network (radio access network, RAN) node (or device) that connects the terminal device to a wireless network. The base station may broadly cover various devices of the following names or may be replaced with the following names, for example, a node B (NodeB), an evolved NodeB (evolved NodeB, eNB), a next generation base station (next generation NodeB, gNB), a relay station, an access point (access point, AP), a transmitting and receiving point (transmitting and receiving point, TRP), a transmitting point (transmitting point, TP), a master station MeNB, a secondary station SeNB, a multi-standard radio (MSR) node, a home base station, a network controller, an access node, a wireless node, a transmission node, a transceiver node, a base band unit (base band unit, BBU), a remote radio unit (remote radio unit, RRU), an active antenna unit (active antenna unit, AAU), a remote radio head (remote radio head, RRH), a central unit (central unit, CU), a distributed unit (distributed unit, DU), and a positioning node. The base station may be a macro base station, a micro base station, a relay node, a donor node, or the like, or a combination thereof. Alternatively, the base station may be a communications module, a modem, or a chip disposed in the device or apparatus described above. The base station may further be a mobile switching center, a device that undertakes a base station function in D2D, V2X, or M2M communications, a network side device in a 6G network, a device that undertakes a base station function in a future communications system, or the like. The base station may support networks with a same access technology or different access technologies. A specific technology and a specific device form used by the network device are not limited in embodiments of this application.

The base station may be fixed or mobile. For example, a helicopter or an unmanned aerial vehicle may be configured to act as a mobile base station, and one or more cells may move based on a position of the mobile base station. In another example, a helicopter or an unmanned aerial vehicle may be configured to serve as a device in communication with another base station.

In some deployments, the network device in embodiments of this application may be a CU or a DU, or the network device includes a CU and a DU. The gNB may further include an AAU.

By way of example rather than limitation, in embodiments of this application, the network device may have a mobility characteristic. For example, the network device may be a mobile device. In some embodiments of this application, the network device may be a satellite or a balloon station. In some embodiments of this application, the network device may alternatively be a base station located on land, water, or the like.

In embodiments of this application, the network device may provide a service for a cell, and the terminal device communicates with the network device by using a transmission resource (for example, a frequency domain resource or a spectrum resource) used by the cell. The cell may be a cell corresponding to the network device (for example, a base station). The cell may belong to a macro base station or belong to a base station corresponding to a small cell (small cell). The small cell herein may include a metro cell (metro cell), a micro cell (micro cell), a pico cell (pico cell), a femto cell (femto cell), or the like. These small cells have small coverage and low transmit power, and are suitable for providing a high-speed data transmission service.

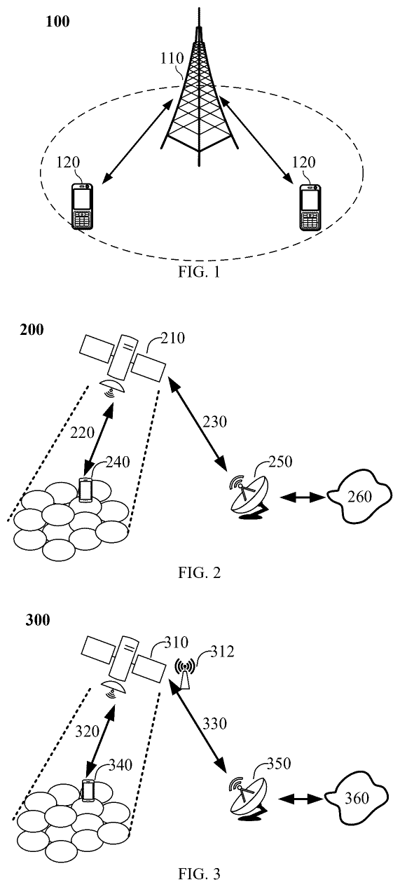

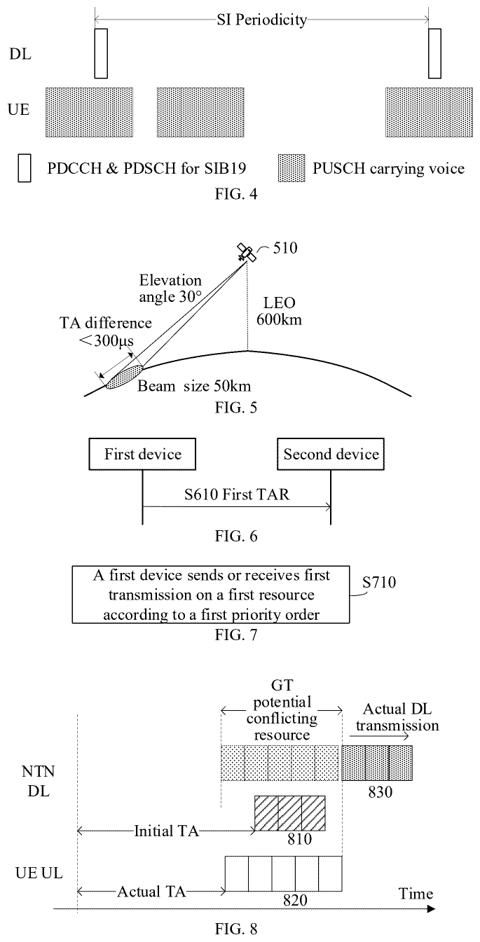

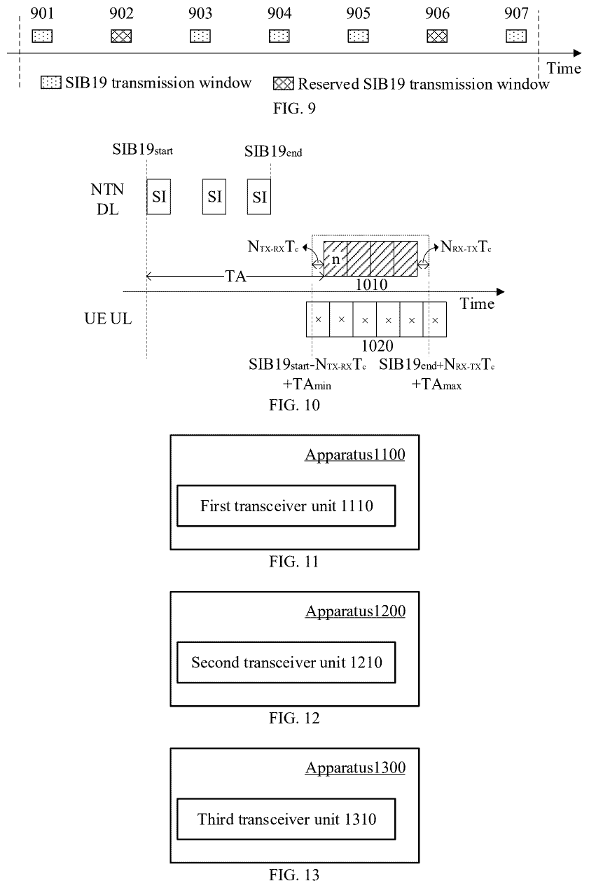

For example, FIG. 1 is a schematic diagram of an architecture of a communications system according to an embodiment of this application. As shown in FIG. 1, the communications system 100 may include a network device 110, and the network device 110 may be a device that communicates with the terminal device 120 (or referred to as a communications terminal or a terminal). The network device 110 may provide communication coverage for a specific geographical area, and may communicate with a terminal device located in the coverage area.

FIG. 1 exemplarily shows one network device and two terminal devices. In some embodiments of this application, the communications system 100 may include multiple network devices, and coverage of each network device may include another quantity of terminal devices. This is not limited herein.

For example, FIG. 2 is a schematic architecture diagram of the foregoing NTN system. The NTN system 200 shown in FIG. 2 uses a satellite 210 as an air platform. As shown in FIG. 2, a satellite radio access network includes a satellite 210, a service link 220, a feeder link 230, a terminal device 240, a gateway (gateway, GW) 250, and a network 260 including a base station and a core network.

The satellite 210 is a spacecraft based on a space platform. The service link 220 refers to a link between the satellite 210 and the terminal device 240. The feeder link 230 refers to a link between the gateway 250 and the satellite 210. The Earth-based gateway 250 connects the satellite 210 to a base station or core network, depending on the choice of the NTN architecture.

The NTN architecture shown in FIG. 2 is a bend-pipe transponder architecture. In this architecture, the base station is located on the earth behind the gateway 250, and the satellite 210 acts as a relay. The satellite 210 operates as a relay for forwarding signals from the feeder link 230 to the service link 220, or forwards signals from the service link 220 to the feeder link 230. That is, the satellite 210 does not have a function of a base station, and communication between the terminal device 240 and the base station in the network 260 needs to be forwarded by the satellite 210.

For example, FIG. 3 is another schematic architecture diagram of an NTN system. As shown in FIG. 3, the satellite radio access network 300 includes a satellite 310, a service link 320, a feeder link 330, a terminal device 340, a gateway 350, and a network 360. Different from FIG. 2, a base station 312 is provided on the satellite 310, and a network 360 behind the gateway 350 includes only a core network.

The NTN architecture shown in FIG. 3 is a regenerative transponder architecture. In this architecture, the satellite 310 carries the base station 312, and may be directly connected to the earth-based core network by using a link. The satellite 310 has a function of a base station, and the terminal device 340 may directly communicate with the satellite 310. Thus, the satellite 310 may be referred to as a network device.

The communications system in the architecture shown in FIG. 2 and FIG. 3 may include multiple network devices, and coverage of each network device may include another quantity of terminal devices. This is not limited in embodiments of the application.

In embodiments of the application, the communications system shown in FIG. 1 to FIG. 3 may further include another network entity such as a mobility management entity (mobility management entity, MME) and an access and mobility management function (access and mobility management function, AMF). This is not limited in embodiments of the application.

It should be understood that, in embodiments of the application, a device that has a communications function in a network/system may be referred to as a communications device. The communications system 100 shown in FIG. 1 is used as an example. The communications device may include a network device 110 and a terminal device 120 that have a communications function. The network device 110 and the terminal device 120 may be specific devices described above. Details are not described herein again. The communications device may further include another device in the communications system 100, such as a network controller and a mobility management entity, which is not limited in embodiments of the application.

For ease of understanding, some related technical knowledge related to the embodiments of this application is first described. The following related technologies, as optional solutions, may be randomly combined with the technical solutions of embodiments of this application, all of which fall within the protection scope of embodiments of this application. Embodiments of this application include at least part of the following content.

With the development of communications technologies, communications systems (e.g., 5G) will integrate the market potential of satellite and terrestrial network infrastructures. For example, the 5G standard makes NTN, including satellite segments, part of a recognized 3rd generation partnership project (3GPP) 5G connection infrastructure.

NTN is a network or network segment that uses a radio frequency (radio frequency, RF) resource on an unmanned aerial system (unmanned aerial system, UAS) platform. Using satellites as an example, communications satellites are classified into a low earth orbit (low earth orbit, LEO) satellite, a medium earth orbit (medium earth orbit, MEO) satellite, a geostationary earth orbit (geostationary earth orbit, GEO) satellite, a high elliptical orbit (high elliptical orbit, HEO) satellite, and the like according to different orbital altitudes. The LEO is an earth-centered orbit with a height of 2000 km or less, or at least 11.25 cycles per day, and an eccentricity less than 0.25. Most artificial objects in outer space are located in LEO. The LEO satellite operates around the Earth at a high speed (mobile), but on predictable or definite orbits.

Satellites with different orbital altitudes have different orbital periods. For example, the LEO has a typical height of 250-1500 km, and a track period of 90-120 minutes. The MEO has a typical height of 5000-25000 km, and a track period of 3-15 hours. The GEO has a height of about 35786 km, and a track period of 24 hours.

It may be learned from FIG. 2 and FIG. 3 using a satellite as an example, a typical scenario in which the terminal device accesses the NTN system relates to an NTN transparent payload (payload) or an NTN regenerative payload. The bend-pipe transponder architecture shown in FIG. 2 corresponds to an NTN transparent payload, and the regenerative transponder architecture shown in FIG. 3 corresponds to an NTN regenerative payload.

In the NTN system, a terminal device located on a ground performs wireless communication by using an air platform. Different from a terrestrial network (terrestrial network, TN), a transmission delay in the NTN is generally relatively large. For example, because satellites are usually located over hundreds of kilometers above the surface of the earth, propagation delays in the NTN are much longer. Specifically, the propagation delay in the NTN varies from several milliseconds to hundreds of milliseconds, depending on the heights of the platforms on the satellites or machines and the load types in the NTN.

Due to a large propagation delay, a related problem may need to be solved when a technology in a ground network is deployed in the NTN system. For example, in the IoT NTN of release-17 (release-17, Rel-17) and Rel-18, the NB-IoT technology is enhanced to support NTN.

With development of the IoT technology, in many IoT-like cases except the NB-IoT, a reduced capability (reduced capability, RedCap) terminal device may provide a service very well. That is, the RedCap device may also be applied to the NTN system.

RedCap is a new terminal capability introduced by Rel-17. The terminal device related to the RedCap may have reduced complexity and new power saving functions, so it is more conducive to large-scale commercial application in the commercial network of the 5G. NR is used as an example. The RedCap may reduce a capability of the device by reducing a bandwidth, a quantity of transceiver antennas or a rate, modifying a modulation scheme, and introducing a half-duplex mode, so as to reduce complexity of the terminal device, reduce terminal costs and power consumption, and prolong a service life. Therefore, requirements of RedCap are different from requirements of LTE for machines (LTE for machines, LTE-M) and NB-IoT.

It can be learned from the foregoing that the RedCap supports a half-duplex (half duplex, HD) operating mode. In a working mode of a frequency division multiplexed (frequency division multiplexed, FDD) operating mode, a communications device may transmit/receive at different times and frequencies. Compared with a full-duplex FDD (full duplex FDD, FD FDD) mode, a device supporting the half-duplex FDD (HD FDD) mode may not require a duplexer, thereby reducing complexity and costs. For example, the half-duplex FDD device may relax a requirement on a component in a radio frequency front end, and replace the duplexer with a low-cost transceiver antenna switch and a low-pass filter.

The half-duplex mode requires transmitting and receiving at different times and frequencies, while a Redcap device in the HD FDD mode may be required to simultaneously performs downlink (downlink, DL) receiving and uplink (uplink, UL) sending. That is, a case in which a collision between an uplink and a downlink may occur on the terminal side.

Further, in the NTN system, there is a large propagation delay on uplink and downlink. Due to the characteristics of the NTN system, the HD FDD technology that requires uplink and downlink transmissions at different points may lead to a more complex conflict scenario.

As an example, in NR NTN, the terminal device needs to receive a system information block (system information block, SIB) to perform communication. For example, the terminal device needs to read the SIB19 from time to time to keep the ephemeris up to date. Specifically, the terminal device may determine, according to validity of the ephemeris table and the last time of obtaining the SIB19, when to read the SIB19. The SIB19 is usually carried in a system information (system information, SI) message. The message is transmitted on a downlink shared channel (downlink-shared channel, DL-SCH). Only the SIB with the same periodicity (periodicity) can be mapped to the same SI message. Each SI message is sent in a periodic time domain window. All SI messages may have SI windows of a same length. Each SI message is associated with an SI window, and SI windows of different SI messages do not overlap with each other. That is, a determined SI window is only used to send a corresponding SI message. The system can send an SI message for multiple times in an SI window. Thus, the SIB19 may be sent periodically during the SI window associated with the SIB19. The SI window duration and start time are known to the terminal device.

It can be learned from the foregoing that the SIB19 is periodically broadcast, and there are many SIB19 transmissions in the validity period of the ephemeris. Therefore, the full-duplex terminal device has a large quantity of opportunities to read the SIB19. However, for half-duplex terminal devices, potential collisions between UL and SIB19 transmissions may reduce the opportunities to read the SIB19. In addition, scheduling the terminal device through a network device (e.g., gNB) to avoid UL transmission during transmission of all SIB19 is not desirable, as this will result in loss of UL throughput of the terminal device and may also degrade or exclude some UL services for the half-duplex terminal device. For example, if a UL voice packet is transmitted in a manner of 16 transmissions per 20 milliseconds, it is almost impossible to avoid a conflict between a physical uplink shared channel (physical uplink shared channel, PUSCH) carrying a voice (voice) and SIB19 transmission by gNB scheduling.

For ease of understanding, the following exemplarily describes, with reference to FIG. 4, a conflict between uplink transmission and downlink transmission of a terminal device (for example, UE) and SIB19. Referring to FIG. 4, UL transmission of a terminal device is PUSCH transmission that carries a voice, and the transmission is dynamic. In FIG. 4, downlink transmission is transmission of a physical downlink control channel (physical downlink control channel, PDCCH) or a physical downlink shared channel (physical downlink shared channel, PDSCH) used for SIB19, which is a periodical transmission based on an SI periodicity.

As shown in FIG. 4, two PDCCHs/PDSCHs conflict with PUSCHs carrying a voice. According to a related rule, when a conflict exists, the terminal device may cancel voice transmission and/or abandon SIB19 reception. Based on this rule, a conflict between SIB19 and PUSCH may result in unacceptable voice quality and/or loss of opportunity to read SIB19.

As an example, in the NTN system, satellite mobility may cause a change of a propagation delay, and the network device can hardly schedule uplink or downlink transmission. This is because the network device may not know whether a collision occurs on the terminal device side, or which channels/signals may conflict on the terminal device side.

As an example, the network may evaluate a location and a path loss of the terminal device, and notify, by using a media access control control element (media access control control element, MAC CE), an adjustment amount of a timing advance (timing advance, TA) of the terminal device. When the TA of the terminal device is updated, the latest TA report (TA report, TAR) may also be sent by using the MAC CE. For example, in release 17 (release 17, Rel-17), there are two conditions for supporting TAR. In a first case, the terminal device sends the TAR in the following time period: a period of a random access procedure for radio resource control (radio resource control, RRC) connection establishment or RRC connection recovery, and a period of an RRC connection reconstruction procedure. In a second case, when a change of the TA value is equal to or greater than a configured threshold, the terminal device reports the TA. The network device (for example, gNB) may configure the terminal device to report the TAR based on the offset threshold. However, the network device cannot determine whether the terminal device has uplink or downlink service data sent in time for the configuration. In addition, when the TAR report is configured by the network device based on the offset threshold, the terminal device that has no service also needs to report a TA status from time to time, which not only causes extra power consumption of the terminal device, but also occupies a limited resource in the NTN uplink.

In the foregoing example, at a moment T1, in a service area of the satellite 1, the terminal device may calculate a TA value T_{TA} in a TA report, and report the TA value. Calculation of T_{TA} is performed based on the following formula:

$${T}_{TA} = ( {N}_{TA} + {N}_{TA , offset} + {N}_{TA , adj}^{common} + {N}_{TA , adj}^{UE} ) {T}_{c} ;$$

T_{c} is a basic time unit; N_{TA} is a TA value indicated in the TA command sent by the network device by using the MAC CE. For transmission of a physical random access channel (physical random access channel, PRACH), the N_{TA} may be defined as 0. N_{TA,offset} is a fixed offset value associated with a frequency band and/or subcarrier spacing;

$${N}_{TA , adj}^{common}$$

is a common TA, that is, a common network-controlled TA value for all terminal devices in the NTN cell, and the TA value may include any timing offset determined by the network to be necessary; N_{TA,offset} is a dedicated TA (UE-specific TA) of the terminal device, and is estimated by the terminal device, and is used to compensate for a service link delay between the terminal device and the satellite.

As an example, in NR NTN, a TA mismatch (TA misalignment) problem may occur if the network device does not receive any TAR, or the TAR is outdated, or the reporting granularity of the TAR is not fine enough. For example, if the terminal device does not report the TAR, the network device cannot set some key scheduling variables (for example, K_{cell, offset}, K_{UE, offset}). For another example, when a location of a terminal device changes, an outdated TAR may cause a difference between an actual TA and an indicated TA. This difference may be the difference between the minimum TA (min TA) and the maximum TA (max TA). The difference may also be in proportion to a round-trip time (round-trip time, RTT) difference of the terminal device. The RTT difference may depend on a location of the terminal device in the cell. For another example, a reporting granularity of the TAR in the NTN may be 1 ms, and when a difference between a minimum TA and a maximum TA in a cell is less than a reporting granularity of the TAR, TA mismatch may occur.

For ease of understanding, the following uses LEO as an example to describe a TA mismatch scenario in the NTN system with reference to FIG. 5. As shown in FIG. 5, a height of the LEO from the ground is 600 km, and a beam size (beam size) is 50 km. When a target elevation angle (elevation angle) is 30 degrees, the TA difference between the shortest RTT and the longest RTT is about 300 μs. A TA difference in FIG. 5 is a difference between a minimum TA and a maximum TA in a serving cell. 300 us corresponds to approximately 4 to 5 orthogonal frequency division multiplex (orthogonal frequency division multiplex, OFDM) symbols at a 15 kHz subcarrier spacing (subcarrier spacing, SCS). However, a reporting granularity of 1 ms is equivalent to 14 OFDM symbols at 15 kHz SCS.

As can be seen from FIG. 5, for the 600 km LEO, the difference between the minimum TA and the maximum TA may be less than the TA reporting granularity (e.g., 1 ms) when the beam size is 50 km and the target elevation angle is 30 degrees. When the reporting granularity is 1 ms, TA mismatch may occur within 1 ms regardless of satellite parameters. Therefore, at least 1 ms of resources may need to be reserved between DL and UL transmissions to avoid mis-scheduling of terminal devices. In particular, the transmission duration in the NTN is generally longer than that in the TN due to uplink transmission repetitions. Therefore, in the LEO, the main reason for TA mismatches may be that the TA reporting granularity is not fine enough, rather than the outdated TAR.

In conclusion, when a technology supporting half-duplex such as RedCap is applied to an NTN system, a method of supporting a half-duplex operation by NTN designation needs to be studied. Therefore, how to deploy terminal devices that support half-duplex in the NTN system, how to reduce or avoid a possible conflict in the half-duplex working mode, and how to perform transmission in a conflict is a technical problem that needs to be resolved.

It should be noted that the foregoing problem that uplink and downlink transmission of the NTN system conflicts because the RedCap supports the half-duplex mode and the TA report granularity is relatively large is merely an example. Embodiments of the application may be applied to a communication scenario of any type of terminal devices supporting half-duplex communication or having a relatively large TA report granularity.

For the foregoing problems, an embodiment of this application proposes a wireless communication method. In this method, the first device may determine, according to a service serving time and/or a service type, whether to send a first TAR. It can be learned that a trigger event of the first TAR includes service-related information of the first device, so that a reporting granularity of the first TAR can be finer, so as to reduce a transmission conflict. For ease of understanding, the following describes the embodiment in detail with reference to FIG. 6. FIG. 6 provide the description from a perspective of interaction between the first device and the second device.

In some embodiments, the first device may be a terminal device that performs uplink transmission to the network device, or may be a terminal device that receives downlink transmission from the network device, which is not limited herein. For example, the first device may be UE, or may be a relay device.

As an example, the first device may be a terminal device in the NTN system. In some embodiments, the first device may be a terminal device in a NB-IoT system. In some embodiments, the first device may be a terminal device in a network with a relatively long communication delay.

As an example, the first device is located in a coverage area of a satellite. For example, the first device is an NTN Internet of Things terminal.

In some embodiments, the first device may be a terminal device that performs sidelink transmission with another terminal device.

In some embodiments, the first device is a terminal device or a relay device that supports half-duplex communication. For example, the first device is the foregoing RedCap device. For example, the first device is any low-energy-consumption device that supports the half-duplex mode.

As an example, the first device may support both a half-duplex mode and another mode. The another mode is, for example, a full-duplex mode.

As an example, the first device may be any terminal device of multiple terminal devices that support half-duplex communication in the NTN cell, which is not limited herein. For example, the first device is corresponding to a serving cell of the NTN.

In some embodiments, the second device may be a network device in any communications system or a device on a network side. The communications system is, for example, an NTN system. In some embodiments, the second device may include a satellite in the NTN system, and the first device is a terminal device in a cell served by the satellite. For example, when a base station is deployed on a satellite, the first device may directly communicate with the base station on the satellite. For example, when a satellite is used as a relay, the first device may communicate with the network device located on the ground by using the satellite.

As an example, when the first device includes a satellite, the second device may be located in a service area of the satellite at a current moment, so as to send or receive a first transmission by using the satellite.

In some embodiments, the second device may be a terminal device or a relay device that communicates with the first device in a sidelink communications system.

Referring to FIG. 6, in step S610, the first device sends the first TAR to the second device. Correspondingly, the second device receives the first TAR sent by the first device. The first device may send the first TAR to the second device according to first information. The first information is used to trigger the first device to send the first TAR, that is, the first TAR is triggered according to the first information.

In some embodiments, the first information may also be referred to as TAR trigger information. The first device sends the first TAR according to the first information. Alternatively, the first device determines, according to the first information, whether to trigger the first TAR.

In some embodiments, the first information may include an indication of triggering TAR sent by the higher layer and a TA offset threshold configured by the higher layer. It may be learned from the foregoing that if the first device previously does not report the TA value to the current serving cell, or if the change between the current estimated value of the TA value and the TA value reported last time is equal to or greater than the TA offset threshold (if configured), the first device is triggered to send the TAR. To implement a finer TA report granularity, a trigger event of the first TAR may be added according to an actual transmission requirement.

In some embodiments, the first information may further include information related to a service of the first device. In some embodiments, the first TAR may be triggered according to multiple events related to a service. The multiple events related to the service are, for example, a service level, a service type, a serving time limit, and a service serving time.

In an implementation manner, the first information may include a service event of the first device and/or a service type of the first device. Considering an indication or configuration of a higher layer, the first information may include one or more of the following information: an indication of triggering TAR from a higher layer, a TA offset threshold configured by the higher layer, a service serving time of the first device, and a service type of the first device.

For example, the first TAR may be triggered according to one or more of the following information: a TAR triggering indication from a higher layer, a TA offset threshold configured by a higher layer, a service serving time of the first device, or a service type of the first device. That is, in response to an event related to any information in the foregoing information, the first device may send the first TAR. The higher layer may also be referred to as an upper layer.

As an example, the TA offset threshold is used to trigger TAR reporting, which may also be referred to as a trigger offset threshold.

In some embodiments, the first information includes a service serving time of the first device. As an example, the service serving time of the first device may indicate a time during which a service can be provided for the first device currently, or a current remaining serving time of a service. Optionally, the service serving time of the first device may be determined according to a capability and a location of the first device, or may be determined according to a time during which a current cell provides a service.

In a possible implementation, when the cell corresponding to the first device is a cell in the NTN (an NTN serving cell corresponding to the first device), a service serving time of the first device may be determined according to a location of the first device and/or a time during which a satellite of the NTN provides a service. For example, when the location of the first device changes, the first device may leave the current cell, reducing a service serving time. For another example, when a current satellite of the NTN cell is about to leave a cell in which the first device is currently located, a service serving time may be less than a first threshold.

For example, when the first device receives the TAR trigger indication sent by the higher layer, and service serving time of the first device is greater than a first threshold, the first device sends the first TAR. That is, when the service serving time is long, the first TAR is sent in a timely manner, so as to reduce possible transmission conflicts by using a more precise reporting granularity of the TAR.

For example, when the service serving time of the first device is equal to or less than the first threshold, the first device does not send the first TAR. When the remaining time of the service decreases, the first device may not send the first TAR, thereby reducing unnecessary power consumption. For example, when the service serving time of the first device is T-UE, and the first threshold is set to T_{target}, if T-UE is greater than T_{target}, sending of the first TAR is triggered. If T-UE is less than T_{target}, the first device does not trigger sending of the first TAR, so as to avoid unnecessary power consumption of the first device.

In a possible implementation, the first threshold may be configured by a higher layer, or may be determined by the first device itself.

In a possible implementation, in the NTN system, the first threshold may be determined according to a serving time of the satellite. The satellite currently provides a service for a serving cell in which the first device is located. The serving time of the satellite may be a remaining serving time of the current satellite in the serving cell. For example, the first threshold T_{target} may be 10%×T-service, and T-service is a serving time of the NTN satellite. For example, when the service serving time of the first device is within T-service, sending of the first TAR is triggered. When the service serving time of the first device is outside T-service, sending of the first TAR is not triggered.

In some embodiments, the first information includes a service type of the first device. The service type of the first device may refer to a type of a resource required by the service of the first device, may also refer to an application scenario of the service, or may refer to a service level, which is not limited herein.

As an example, a service type of the first device may be used to set a timer related to TAR triggering. By the method of triggering TAR by a timer based on the service type, the report granularity of the TAR can be related to the service type. That is, the first device may trigger sending of TAR according to a timer corresponding to a service type.

For example, the service type of the first device is used by the first device to set a first timer related to the TA offset threshold. That is, the first device may set the first timer related to the TA offset threshold according to the service type. For different service types, different duration may be set for the first timer. Therefore, the setting of the offsetThresholdTA (TA offset threshold) is not only related to location information, but also related to a service type. For different services, offsetThresholdTA has different values. For example, a smaller offsetThresholdTA value may be set for a higher service level of the first device, thereby implementing a smaller trigger offset threshold.

Optionally, the first device may send the first TAR based on a TAR triggering indication from the upper layer.

Optionally, when the offsetThresholdTA is configured by the upper layer, if a change of the TA value is equal to or greater than offsetThresholdTA, the first device sends the first TAR.

Optionally, the first device may trigger sending of the first TAR based on the service serving time and an indication from a higher layer, so as to avoid or reduce conflicts. After the triggering by the service serving time is introduced, the first device may detect a serving time of the first device after receiving the TAR triggering indication from the upper layer, so as to determine, according to a relationship between the serving time and a threshold, whether to send the first TAR.

Optionally, the first device may determine, based on location information and a service type, whether to send the first TAR.

In some embodiments, in order to achieve more accurate TA reporting, a related TA reporting mechanism may be directly enhanced. In an implementation, the first device may use a reporting MAC CE of the same size as TAR MAC CE (two 8-bit bytes) to provide a more granular report granularity. In a related technology, a TA value currently sent by the first TAR by using two 8-bit bytes of the MAC CE is T_{TA}, and the TA value may be referred to as a first TA value in the first TAR. It may be learned from the foregoing calculation formula of T_{TA} that the first TA value in the first TAR may be determined according to four parameters of a TA value (N_{TA}) in a TA command, a first offset value (N_{TA,offset}), a common TA value

$$( {N}_{TA , adj}^{common} ) ,$$

and a dedicated TA value

$$( {N}_{TA , adj}^{UE} )$$

of the first device.

It should be understood that when TAR MAC CE is corresponding to two 8-bit bytes, the two 8-bit bytes may be a first byte segment corresponding to the first TAR. When TAR MAC CE is corresponding to a byte segment of another length, the byte segment of the another length is a first byte segment corresponding to the first TAR.

As an embodiment, to provide a more granular reporting granularity, the first device may use MAC CE to report only the dedicated TA value that is currently estimated by the first device, that is, a component

$$( {N}_{TA , adj}^{UE} )$$

specific to the first device in the T_{TA}. That is, when the first TAR is triggered, the first device may send only the TA value specific to the first device by using the first byte segment.

As an embodiment, to provide a more granular reporting granularity, the first device may use MAC CE to report only a change between the current T_{TA} from the last reported TA value, i.e., ΔT_{TA}. That is, when the first TAR is triggered, the first device may send the difference between the first TA value and a second TA value by using the first byte segment, where the second TA value is a TA value in a second TAR sent last time by the first device. It should be understood that the last time may be a previous sending time adjacent to the sending time of the first TAR, or may be an initial sending time.

In the foregoing embodiment, the dedicated TA value or ΔT_{TA} may be used as a substitute for the entire T_{TA} value in report to the gNB within a period of time. This is because the calculating parameter

$${N}_{TA , adj}^{common}$$

is still valid and known on the UE and gNB sides within the period of time. Therefore, the two 8-bit bytes of the enhanced reporting MAC CE may be fully used to send a variable in the entire TA value (the first TA value).

In an embodiment, the first byte segment corresponding to the first TAR may be divided into at least two second byte segments. One of the at least two second byte segments is used to send a dedicated TA value of the first device, or a difference (ΔT_{TA}) between the first TA value in the first TAR and the second TA value. For example, the first device may report a dedicated TA value of the first device or ΔT_{TA} by using a 4-bit byte. It can be learned that two 8-bit bytes may facilitate the first device to more frequently report a related parameter of the TA.

In some embodiments, the second device may configure a first resource according to the first TAR. When the TA value in the first TAR is relatively accurate, a probability that a transmission conflict occurs on the first resource is reduced. That is, in some scenarios, the first resource may be determined according to the first TAR reported by the first device. The first resource will be specifically described with reference to FIG. 7.

It may be learned from FIG. 6 that, in embodiments of the application, multiple trigger timings are added for the first TAR, and an enhanced reporting manner is proposed, so as to implement reporting of finer granularity. It can be learned from the foregoing that in the NTN system, a distance between a satellite and a ground communication device is relatively long, and a transmission delay is relatively long. For half-duplex communication in the NTN system, the first device may still have a conflict between uplink and downlink transmissions even if the reporting granularity of the first TAR is finer.

To resolve a problem of how to perform transmission in a conflict, an embodiment of this application proposes another wireless communication method. In this method, the first transmission performed by the first device on the first resource may be determined according to a first priority order. The first resource is one of multiple resources related to half-duplex communication, and multiple priority orders including the first priority order may be used for the multiple resources. It can be learned that appropriate transmissions on multiple resources used for half-duplex communication may be separately selected based on different priority orders, so that a transmission type on a half-duplex communication resource can be flexibly set based on a communication requirement, which helps reduce or avoid transmission conflicts of the first device, and improves transmission efficiency.

For ease of understanding, the following describes in detail the wireless communication method provided in the embodiments of this application with reference to FIG. 7. The method shown in FIG. 7 is executed by a first device, and the first transmission in FIG. 7 is transmission between the first device and the second device. For brevity, the terms already explained in FIG. 6 are not described again.

Referring to FIG. 7, in step S710, the first device sends or receives the first transmission on the first resource according to the first priority order. Correspondingly, the second device may receive or send the first transmission on the first resource.

The first transmission may be any type of channel, signal, or signaling transmission, which is not limited herein. For example, the first transmission may be uplink channel transmission such as PUSCH transmission or PUCCH transmission, downlink channel transmission such as PDCCH transmission or PDSCH transmission, or side line channel transmission such as PSSCH transmission or PSCCH transmission. For another example, the first transmission may be transmission of an uplink reference signal, a sidelink reference signal, or a downlink reference signal. For another example, the first transmission may be transmission of signaling of any type.

As an example, the first transmission may be any transmission that is transmitted by using an air interface resource.

In some embodiments, the first transmission may be any one of a plurality of transmissions. That is, the first transmission is one of multiple types of transmissions. The multiple types of transmissions may include transmissions of any of the foregoing multiple channels, signals, or signaling, which is not limited herein.

In some embodiments, multiple types of transmissions may be classified according to a transmission direction or transmission importance to facilitate determining the first transmission.

In a possible implementation, the multiple types of transmissions may be classified into a first category of transmissions and a second category of transmissions other than the first category of transmissions, where a priority of the first category of transmissions is higher than a priority of the second category of transmissions. That is, when both a transmission in the first category and a transmission in the second category need to be transmitted on the first resource, the transmission in the first category is preferentially sent.

Optionally, the first category of transmissions may include one or more of the following: SIB downlink transmission, a TAR and/or a scheduling request (scheduling request, SR) triggered by a TAR; and transmission enabled/disabled with hybrid automatic repeat request (hybrid automatic repeat reQuest, HARQ) HARQ feedback; or uplink transmission based on demodulation reference signal (demodulation reference signal, DMRS) bundling. The DL/UL transmission of the first device or the second device includes the four types of transmissions, and a priority of the four types of transmissions is higher than other DL/UL data transmission.

As an example, downlink transmission of the SIB may include downlink transmission of SIB19, or may be downlink transmission of SIB19. Downlink transmission of the SIB may also be referred to as downlink receiving of the SIB. Downlink transmission of the SIB19 may also be referred to as downlink receiving of the SIB19. When the first category of transmissions includes downlink transmission of the SIB19, the terminal device can read the latest information of the ephemeris in time.

As an example, a TAR and/or an SR triggered by a TAR belongs to uplink transmission related to TAR. In NR NTN, uplink transmission related to TAR is important information related to uplink timing. To enable a network device of the NTN to set an appropriate uplink timing offset (for example, K_{cell, offset}, and K_{UE, offset}), the network device of the NTN needs to receive information about the TAR in a timely manner. Therefore, the terminal device needs to perform uplink transmission of a TAR and/or an SR triggered by a TAR in a timely manner.

As an example, in the NTN system, some HARQ processes may be enabled/disabled with HARQ feedback. These transmissions enabled/disabled with HARQ feedback have different requirements from other transmissions. Therefore, transmission priorities of DL/UL may be set according to whether HARQ feedback is enabled/disabled. For example, HARQ feedback disabled transmissions may have a higher priority. If the priority of such transmissions is low, cancelling these transmissions in the event of a conflict may result in failing to receive the entire data.

As an example, the DMRS bundling may represent a dedicated demodulation reference signal (dedicated demodulation reference signals, DM-RS) bundling. In uplink transmission based on DMRS bundling, phase continuity needs to be ensured. Therefore, after the first category of transmissions includes the uplink transmission based on DMRS bundling, phase continuity can be ensured to some extent by raising the priority.

That the first device sends or receives the first transmission may be replaced with that the first device performs the first transmission. In some embodiments, when the transmission corresponding to the first resource includes the first-type transmission, the first transmission belongs to the first-type transmission. When the transmission corresponding to the first resource does not include the first-type transmission, the first transmission may be transmission of a higher priority in the second-type transmission.

It should be noted that transmission corresponding to the first resource may refer to transmission that is expected to be performed on the first resource, or is (pre) configured to be performed on the first resource. When the first resource is corresponding to multiple types of transmissions, the multiple types of transmissions may be performed on the first resource. Because the half-duplex mode requires transmitting and receiving at different times and different frequencies, a transmission conflict may occur in multiple types of transmissions on the first resource.

The first resource is one of multiple resources related to half-duplex communication. The multiple resources related to half-duplex communication refer to that the multiple resources are used by a communications device to perform half-duplex communication in a network. In some embodiments, the multiple resources may be dedicated resources for half-duplex mode. In some embodiments, the multiple resources may be resources that support both half-duplex mode and full-duplex mode. In some embodiments, the multiple resources may be unlimited radio resources.

For example, the first resource may be used by the first device and the second device to perform data transmission in a determined direction in the NTN.

In some embodiments, half-duplex communication includes uplink transmission, downlink reception (downlink transmission), and sidelink transmission based on the half-duplex mode. That is, the first resource may be an uplink transmission resource, may be a downlink transmission resource, or may be a sidelink transmission resource.

In some embodiments, the multiple resources may be determined according to a network configuration, may be determined according to a sending requirement of the terminal device, or may be determined according to a TAR reported by the terminal device. The first resource determined by the TAR while be described later with reference to the multiple trigger timings of the TAR.

For example, the multiple resources may be periodic transmission resources. For example, the multiple resources may be multiple transmission windows of the SIB. For example, the multiple resources may include multiple transmission windows of the SIB19, and the first resource may be any one or more transmission windows in the multiple transmission windows.

For example, the multiple resources may be reserved resources set by the network device or the terminal device for potential DL/UL conflicts. For example, the setting of guard time (GT) can support potential resource conflicts in a NR NTN with misaligned TA. If both DL and UL resources exist in the GT, the network side and the terminal side may consider these resources as potential DL/UL conflict resources.

For example, the multiple resources may be multiple time-frequency resources of any size, which is not limited herein.

For example, the multiple resources may include multiple consecutive time-frequency resources, or may include multiple discontinuous time-frequency resources. The first resource may be a continuous time-frequency resource, or may be a discontinuous time-frequency resource.

For example, the multiple resources may be multiple different types of resources, and the first resource is one type of resource in the multiple types of resources. The multiple different types of resources may include periodically configured resources, preconfigured specific resources, resources for specific transmission, and the like.

For example, the first resource may be any resource in a type of resource. For example, when the multiple resources include multiple transmission windows periodically configured and the dynamically configured resources, the first resource may be a part of the multiple transmission windows periodically configured.

In some embodiments, when the first resource is corresponding to multiple types of transmissions, the first device needs to select one of the multiple types of transmissions for execution. The transmission selected by the first device from the multiple types of transmissions corresponding to the first resource is the first transmission.

That the first device sends or receives the first transmission on the first resource according to the first priority order may be replaced with: the first device determines, according to the first priority order, the first transmission corresponding to the first resource. It can be learned that the first transmission may be transmission with a highest priority in the multiple types of transmissions corresponding to the first resource. That is, the first device determines the first transmission from the multiple types of transmission in a descending order of priorities.

The first priority order is one of multiple priority orders used for the multiple resources. Multiple priority orders may be separately set based on different priority principles. For example, the multiple priority orders may further include a second priority order, and a principle of setting the second priority order is different from a principle of setting the first priority order.

When multiple priority orders are used for the multiple resources, the first device or the second device may select, for different resources, corresponding transmissions based on different priority orders, so as to avoid a relatively low throughput of low-priority transmission when only one priority order exists. That is, any type of transmission has different priorities on different resources. For example, downlink transmission of SIB19 has a higher priority in some transmission windows and a lower higher priority in other transmission windows. In a window with a higher priority, the first device may perform downlink receiving of the SIB19, so as to ensure timely updating of the ephemeris information. In a window with a lower priority, the first device may perform uplink transmission, so as to improve a throughput of uplink transmission, thereby improving transmission efficiency.

As an example, multiple priority orders may be in a one-to-one correspondence with multiple resources. That is, the multiple resources are respectively corresponding to different priority orders, so that the first device and the second device select a transmission type according to the resource.

As an example, any priority order in the multiple priority orders may correspond to at least two resources in the multiple resources. That is, at least two of the multiple resources share a same priority order.

As an example, multiple resources may share a same priority order in a time period, so as to ensure a transmission requirement of a specific type or a specific service type in the time period.

As an example, when the multiple resources include multiple transmission windows of the SIB19, the multiple transmission windows may include two types of transmission windows that are respectively corresponding to different priority orders. For example, the multiple transmission windows may include a first transmission window and a second transmission window. A priority order corresponding to the first transmission window includes that downlink transmission of the SIB19 has a highest priority, and a priority order corresponding to the second transmission window includes that downlink transmission of the SIB19 has a lowest priority. The first transmission window may also be referred to as a reserved SIB19 window.

For example, when the first resource is the first transmission window, in the first priority order, downlink transmission of the SIB19 has a highest priority, and in the second priority order, downlink transmission of the SIB19 has a lowest priority. When the first resource is the second transmission window, in the first priority order, downlink transmission of the SIB19 has a lowest priority, and in the second priority order, downlink transmission of the SIB19 has a highest priority.

For example, a position of a priority of downlink transmission of the SIB19 in a priority order corresponding to the first transmission window is higher than a position of a priority of downlink transmission of the SIB19 in a priority order corresponding to the second transmission window.

As an example, in NR NTN, for a RedCap terminal device that supports HD FDD (e), transmission on the first resource may be determined based on one or more priority rules of NTN specific transmissions.

In some embodiments, the first priority order may include that a priority of the first category of transmissions is higher than a priority of the second category of transmissions, and may further include a priority order of multiple first category of transmissions and/or a priority order of multiple second category of transmissions.

As an example, for the foregoing four types of transmissions of the first category of transmissions, the first priority order may include that: a priority of downlink transmission of SIB19 is the highest, a priority of transmission enabled/disabled with HARQ feedback is the second highest, a priority of a TAR and/or an SR triggered by a TAR is the third highest, and a priority of uplink transmission based on DMRS bundling is the lowest.

As an example, for the foregoing four types of transmissions of the first category of transmissions, the first priority order may include that: a priority of downlink transmission of SIB19 is higher than a priority of transmission enabled/disabled with HARQ feedback, a priority of a TAR and/or an SR triggered by a TAR, and a priority of uplink transmission based on DMRS bundling.

As an example, for the first category of transmissions described above, the first priority order may include that: a priority of transmission enabled/disabled with HARQ feedback is higher than a priority of a TAR and/or an SR triggered by a TAR and a priority of uplink transmission based on DMRS bundling.

As an example, for the foregoing first-type transmission, the first priority order may include that: a priority of a TAR and/or an SR triggered by a TAR is higher than a priority of uplink transmission based on DMRS bundling.

As an example, for the foregoing four types of transmissions in the first category of transmissions, the first priority order may include that: a priority of downlink transmission of SIB19 is the lowest, a priority of transmission enabled/disabled with HARQ feedback is the second lowest, a priority of a TAR and/or an SR triggered by a TAR is the third lowest, and a priority of uplink transmission based on DMRS bundling is the highest.

As an example, for the foregoing four types of transmissions in the first category of transmissions, the first priority order may include that: a priority of transmission enabled/disabled with HARQ feedback is the highest, a priority of downlink transmission of SIB19 is the second highest, a priority of a TAR and/or an SR triggered by a TAR is the third highest, and a priority of uplink transmission based on DMRS bundling is the lowest.

It should be understood that for multiple transmissions in the first category of transmissions, the first priority order may be obtained in other multiple sorting manners. The multiple sorting manners may be corresponding to multiple priority orders, so as to be used to determine the first transmissions on multiple different resources.

It can be learned from FIG. 7 that when a transmission conflict occurs on the first resource, the first device may determine the first transmission according to a first priority order corresponding to the first resource, thereby reducing impact of the conflict on transmission efficiency.

It may be learned from the foregoing description that the first resource may be a resource periodically configured, or may be a resource reserved. When the first resource is a reserved resource configured by a guard-time-based method, the first resource may be related to the first TAR. Compared with the related art, the first TAR may be triggered based on more events to implement a finer TA reporting granularity. By introducing a finer TA report granularity and a smaller trigger offset threshold, the ratio of unavailable resources can be reduced.

In some embodiments, when the reporting granularity of the TA is finer, the network device (second device) can better timely receive the actual TA of the first device, thereby more accurately performing resource configuration for uplink and downlink transmissions. The resource configuration may include configuring for the first device multiple resources including the first resource. It can be seen that a finer TA reporting granularity can effectively reduce uplink-downlink transmission conflicts.

In some embodiments, a smaller trigger offset threshold means that the TAR is sent when a difference between an actual TA and an initial TA of the first device is relatively small, so that the second device updates the TA value in a timely manner.

In some embodiments, the network device may configure, according to the first TAR, resources for multiple types of downlink transmissions to the first device. The multiple types of downlink transmissions may include a PDCCH or a PDSCH, which is not limited herein.

In some embodiments, the network device may configure resources for multiple types of uplink transmissions for the first device according to the first TAR. The multiple types of uplink transmissions may include the SR described above, transmission enabled/disabled with HARQ feedback, and uplink transmission based on DMRS bundling, and may further include another data transmission. The first resource is a resource used for any one of the multiple types of uplink transmissions, which is not limited herein.

As an example, when the first resource is a reserved resource configured based on a GT, a TA value of the first TAR is used to determine the reserved resource.

In embodiments of the application, the trigger timing and the enhanced reporting manner that are newly added to the first TAR may be used separately, or may be used in combination with the methods for determining the first transmission on the first resource based on the first priority order. For example, after the first resource is determined based on the first TAR, the first device may send or receive the first transmission on the first resource according to the foregoing first priority order.

It may be learned from the foregoing that the first resource may be related to the first TAR sent by the first device, or may be a downlink resource configured by the network device, which is not limited herein. For ease of understanding, the following describes multiple types of first resources with reference to FIG. 8 to FIG. 10.

In some embodiments, the first resource may include a reserved resource determined based on a guard time (GT). It may be learned from the foregoing description that a resource corresponding to a guard time may be referred to as a potential DL/UL conflict resource, that is, a potential conflict resource. As an example, a GT value may be set to be large enough to eliminate a synchronization error caused by TA misalignment between the network device and the terminal device.

In some embodiments, the terminal device and the network device know that a resource conflict occurs in a time period corresponding to the GT. Therefore, the guard time may be configured between conflicting transmissions, so as to avoid the conflict. For example, a GT is configured between DL transmission and UL transmission.

In some embodiments, the guard time may be determined according to a first TA value in the first TAR. The first TA value is a UL TA sent by the terminal device. The network device and the terminal device may determine a GT-based DL/UL conflict resource under a same assumption of UL TA. For example, a network device and a terminal device may assume a common TA of a TA value in a latest TA report as UL TA, and then determine a potential DL/UL conflict resource based on GT. For example, under the assumption of a given UL TA, a DL/UL resource will exist within the GT. That is, the first resource corresponding to the GT may be used for DL/UL transmission.

As an example, whether DL transmission and UL transmission overlap in time domain is determined based on an actual TA known to both the network device and the first device, and the actual TA is determined by using the TAR reported by the first device. That is, the guard time is determined based on the first TAR of the current time instead of the initial TA of the first device, which may avoid a TA mismatch problem. For example, the network device and the first device may first determine based on an interval (GAP) between the most recently reported actual TA

$$( {T}_{TA}^{Report} )$$

and the initial TA. Ine interval may be an interval between an actual TA and an initial TA, or may be an interval (difference) Δ_{TA} between a current TA and a last TA. During the guard period, UL and DL transmission resources do not have a conflict.

In some embodiments, a start time of the guard time is

$${T}_{TA}^{Report} - {Δ}_{TA} ,$$

and an end time of the guard time is

$${T}_{TA}^{Report} + {Δ}_{TA} , where , {T}_{TA}^{Report}$$

represents a current TA value of the first device, and Δ_{TA} represents a difference between a current TA value and a previous TA value. It should be understood that the current TA value of the first device may be an actual parameter closest to the current situation.

Optionally, the current TA value of the first device may be the first TA value in the first TAR, or may be a dedicated TA value of the first device used to determine the first TA value. For example, Δ_{TA} may be ΔT_{TA} described in the foregoing, or may be a difference between two adjacent dedicated TA values.

As an example, the first resource may include a resource corresponding to a guard time. When the guard time is corresponding to multiple types of transmissions, the first device may determine the first transmission from the multiple types of transmissions according to the first priority order. The multiple types of transmissions except the first transmission are performed on a resource after the guard time. The multiple types of transmissions are described above, and details are not described herein again.

As an embodiment, when the multiple transmissions include DL transmission and UL transmission, the first transmission is the DL transmission if the first priority order indicates that a priority of DL transmission is higher than a priority of UL transmission. If the first priority order indicates that a priority of UL transmission is higher than a priority of DL transmission, the first transmission is UL transmission.

In a sub-embodiment of the foregoing embodiment, when the first transmission is DL transmission, the first device sends UL transmission on a resource after guard time. When the first transmission is UL transmission, the first device receives DL transmission on a resource after the guard time.

For ease of understanding, the following provides exemplary description with reference to FIG. 8. The first device in FIG. 8 is UE, and the second device is a network device in NTN. Referring to FIG. 8, in NTN, the second device configures a DL resource 810 of three time units based on an initial TA to send DL transmission. The first device configures a UL resource 820 of five time units based on an actual TA. A GT-based potential conflict resource is configured according to an actual TA, so as to avoid a conflict caused by a difference between an actual TA and an initial TA.

In FIG. 8, a priority order within a GT is that a priority of UL transmission is higher than a priority of DL transmission. As shown in FIG. 8, the first transmission is UL transmission that occupies the resource 820. The actual DL transmission 830 is performed on a resource after the guard time.

Further, if the TA is not updated in a timely manner, an actual TA already has an interval with the initial TA. Therefore, an uplink/downlink conflict resource needs to be subject to an actual TA. A GT may be set on a conflicting resource, so that the DL transmission can avoid a conflicting resource with the uplink transmission based on the first priority order, and can be normally sent and received by the first device.

In some embodiments, the guard time may be determined according to a change value of a distance between the first device and the network device. When the network device is a satellite in the NTN, a higher moving speed of the first device leads to a larger Doppler frequency shift and a larger deviation of TA estimation. Therefore, the GT value can be set to a range, such as 1-14 slots (slot).

In some embodiments, the distance between the first device and the satellite may be represented by an elevation angle. Assuming that a connection line between the terminal device and the satellite is a first connection line, and a connection line between the terminal device and a projection of the satellite on the ground is a second connection line, an elevation angle may be an angle between the first connection line and the second connection line. Assuming that a satellite height is h, a horizontal distance from the first device to the projection of the satellite on the ground is d, and an elevation angle θ of the first device is:

$$θ = arctan ( \frac{h}{d} ) .$$

As an example, a value range of the elevation angle may be 0° to 90°. The guard time may be determined according to an elevation angle of the first device to the satellite in the NTN. A large elevation angle indicates a short distance between the first device and the satellite, in which case the guard time may be relatively short. Accordingly, a small elevation angle indicates a long distance between the first device and the satellite, in which case the guard time may be relatively long.

As an example, the guard time may be determined according to a change value of the elevation angle of the first device to the satellite in the NTN in the first time period. The first time period may be configured by a network device, or may be configured by a higher layer, which is not limited herein. That is, the GT may be valued according to a magnitude of a change of the elevation angle of the first device to the satellite.

As an example, a change value of the elevation angle in the first time period has multiple value ranges. The multiple value ranges include a first value range and a second value range, the first value range corresponds to a first guard time, and the second value range corresponds to a second guard time.

In the foregoing example, when the upper limit value of the first value range is less than the upper limit value of the second value range, the length of the first guard time is less than the length of the second guard time. When the lower limit value of the first value range is less than the lower limit value of the second value range, the length of the first guard time is less than the length of the second guard time.

In the foregoing example, when the upper limit value of the first value range is greater than the upper limit value of the second value range, the length of the first guard time is greater than the length of the second guard time. When the lower limit value of the first value range is greater than the lower limit value of the second value range, the length of the first guard time is greater than the length of the second guard time.

In the foregoing example, when the lower limit value of the first value range is greater than or equal to the upper limit value of the second value range, the length of the first guard time is greater than the length of the second guard time. That is, a larger lower limit value of a value range leads to a larger length of the guard time, as shown in Table 1. For example, Table 1 illustrates an implementation of values of a GT determined based on a change in size (Δθ) of a θ value.

TABLE 1

| Δθ(°) | GT | |
|---|---|---|
| ≤10 | 1 | slot |
| 10 < Δθ ≤ 20 | 2 | slots |
| 20 < Δθ ≤ 30 | 3 | slots |
| 30 < Δθ ≤ 40 | 4 | slots |
| 40 < Δθ ≤ 50 | 5 | slots |
| 50 < Δθ ≤ 60 | 6 | slots |
| 60 < Δθ ≤ 70 | 7 | slots |

| | |
|---|---|
| . . . | . . . |

As an example, GT may be set to a fixed value. For example, this fixed value is set according to a maximum value of the value change (Δθₘₐₓ) of θ to ensure that UL and DL transmissions do not conflict. For example, Δθₘₐₓ may be 90°.

As an example, when actual TA misalignment occurs and actual conflicting resources are greater than GT, exception processing needs to be performed. For example, when the GT is no longer valid, the first device may perform TA reporting to the network device to reconfigure the value of the GT.

It may be learned from the foregoing that the first resource may be a part of multiple transmission windows of the SIB19, that is, the first transmission window. To ensure the time used by the first device to read the SIB19, a subset (reserved SIB19 transmission windows) of the SIB19 transmission windows may be configured as shown in FIG. 9. These reserved SIB19 transmission windows are the first transmission window. As described above, during the first transmission window, the first device may prioritize receiving PDCCH and PDSCH related to SIB19. That is, downlink transmission of the SIB19 has a relatively high priority.

As an example, the first transmission window with a highest priority for downlink transmission of SIB19 may be configured within a specific time.

As an example, multiple transmission windows of the SIB19 are divided into one or more transmission windows belonging to the first transmission window and one or more transmission windows belonging to the second transmission window. In the first transmission window, SIB19 downlink transmission has a higher priority than UL transmission. That is, in a reserved window, the first device needs to wait for sending of the SIB19 to preferentially receive the SIB19 without sending UL data, so as to effectively avoid a conflict. In the second transmission window, the first device may directly send UL data.

As an example, multiple reserved resources for SIB19 included in the first resource may be sent by using a broadcast message.

As an example, the network device may configure two first transmission windows in every 1024 subframes. In response, the first device supporting half-duplex communication will attempt to read the SIB19 during one of the two transmission windows.

For ease of understanding, the following provides exemplary description with reference to the implementation of FIG. 9. FIG. 9 shows seven SIB19 transmission windows 901 to 907. The window 902 and the window 906 are reserved (reserved) SIB19 transmission windows (the first transmission window), and other windows belong to the second transmission window. In the window 902 and the window 906, the first device mainly reads the SIB19. Therefore, downlink transmission of the SIB19 has a highest priority. In the window 901, the window 903 to the window 905, and the window 907, the second device still sends the SIB19. However, the first device does not perform reading, but directly performs uplink transmission, and therefore downlink transmission of the SIB19 has a lowest priority.

In some embodiments, for NR NTN, UL duration is unknown for the NTN network device due to unknown UE TA. However, the NTN network device knows a minimum TA (TAₘᵢₙ) and a maximum TA (TAₘₐₓ) of a cell, and therefore, the network device may use the TA range to determine a duration of an SI corresponding to the SIB19.

The following provides exemplary description with reference to FIG. 10. In FIG. 10, a UE side is a first device side, and an NTN side is a second device side. N_{TX-RX} is a time for switching from sending to receiving by the first device, and N_{RX-TX} is a time for switching from receiving to sending by the first device. T_{C} represents the minimum sampling time period in the system. The switching time is not included in the conflict time.

As shown in FIG. 10, the second device sends a SIB19 by using multiple downlink time units (for example, symbols) corresponding to an SI window, where a start point and an end point of the multiple downlink time units are SIB19ₛₜₐᵣₜ and SIB19_{end}, respectively. In this time period, there may be no conflicts with the uplink, and an SI subset of the SIB19 may be sent in this time period.

A TA in FIG. 10 is in a TA range of a cell, i.e., [TAₘᵢₙ, TAₘₐₓ]. Based on the TA range, the six uplink time units 1020 overlapping with a duration starting from the SIB19ₛₜₐᵣₜ−N_{TX-RX}T_{C}+TAₘᵢₙ conflict with downlink reception of the SIB19. Therefore, for all the first devices in the NTN cell, the uplink time units beyond the duration starting from SIB19ₛₜₐᵣₜ−N_{TX-RX}T_{C}+TAₘᵢₙ to SIB19_{end}−N_{RX-TX}T_{C}+TAₘₐₓ will not conflict with the downlink reception of the SIB19. Therefore, in the duration determined based on the TA range in FIG. 10, downlink reception of the SIB19 may have a higher priority. That is, the first device does not perform uplink transmission within the duration, so that the SIB19 can be correctly received.

The foregoing describes the method embodiments of this application in detail with reference to FIG. 1 to FIG. 10. The following describes in detail the apparatus embodiments of this application with reference to FIG. 11 to FIG. 15. It should be understood that the description of the apparatus embodiments is corresponding to the description of the method embodiments. Therefore, for a part that is not described in detail, reference may be made to the foregoing method embodiments.

FIG. 11 is a schematic block diagram of a wireless communication apparatus according to an embodiment of this application. The apparatus 1100 may be the first device in any embodiments described above. The apparatus 1100 shown in FIG. 11 includes a first transceiver unit 1110.

The first transceiver unit 1110 may be configured to send a first TAR according to first information. The first information includes a service serving time of the first device and/or a service type of the first device.

Optionally, the first information further includes one or more of the following information: a TAR triggering indication sent by a higher layer; or a TA offset threshold configured by a higher layer.

Optionally, the first transceiver unit 1110 is further configured to: send the first TAR when the first device receives the TAR triggering indication and the service serving time of the first device is greater than a first threshold; or skip sending of the first TAR when the service serving time of the first device is equal to or less than the first threshold.

Optionally, the first device corresponds to a serving cell of a NTN, and the first threshold is determined according to a serving time of a satellite corresponding to the serving cell.

Optionally, the first device corresponds to a serving cell of a NTN, and a service serving time of the first device is determined according to a location of the first device and/or a serving time of a satellite corresponding to the serving cell.

Optionally, the service type of the first device is related to a TA offset threshold, and the apparatus 1100 further includes a processing unit, configured to set a first timer related to the TA offset threshold according to the service type.

Optionally, a first TA value in the first TAR is determined according to a TA value in a TA command, a first offset value, a common TA, and a dedicated TA value of the first device. The first transceiver unit 1110 is further configured to: when the first TAR is triggered, send the dedicated TA value of the first device or a difference between the first TA value and a second TA value, by using a first byte segment corresponding to the first TAR. The second TA value is a TA value in a second TAR sent last time by the first device.

Optionally, the first byte segment corresponding to the first TAR is divided into at least two second byte segments, and one of the at least two second byte segments is used to send a dedicated TA value of the first device, or a difference between a first TA value in the first TAR and a second TA value. The second TA value is a TA value in a second TAR sent last time by the first device.

Optionally, the first TAR is used to determine a first resource, and the first transceiver unit 1110 is further configured to send or receive first transmission on the first resource according to a first priority order. The first resource is one of multiple resources related to half-duplex communication, the first priority order is one of multiple priority orders, the multiple priority orders are used for multiple resources, and the first priority order is corresponding to the first resource.

Optionally, the first transceiver unit 1110 in the apparatus 1100 may be a transceiver 1530, and the apparatus 1100 may further include a processor 1510 and a memory 1520, which are specifically shown in FIG. 15.

FIG. 12 is a schematic block diagram of another wireless communication apparatus according to an embodiment of this application. The apparatus 1200 may be the second device in any embodiments described above. The apparatus 1200 shown in FIG. 12 includes a second transceiver unit 1210.

The second transceiver unit 1210 may be configured to receive a first TAR sent by the first device. The first TAR is triggered according to first information, the first information includes a service serving time of the first device and/or a service type of the first device.

Optionally, the first information further includes one or more of the following information: a TAR triggering indication sent by a higher layer; or a TA offset threshold configured by a higher layer.

Optionally, the first TAR is triggered when the first device receives the TAR triggering indication and the service serving time of the first device is greater than a first threshold; or the first TAR is not triggered when the service serving time of the first device is equal to or less than the first threshold.

Optionally, the second device includes a satellite in a NTN, and the first threshold is determined according to a serving time of the satellite.

Optionally, the second device includes a satellite in the NTN, and a service serving time of the first device is determined according to a location of the first device and/or a serving time of the satellite.

Optionally, a service type of the first device is related to a TA offset threshold, the TA offset threshold is related to a first timer, and the first timer is set according to the service type.

Optionally, a first TA value in the first TAR is determined according to a TA value in a TA command, a first offset value, a common TA value, and a dedicated TA value of the first device, and the second transceiver unit 1219 is further configured to: when the first TAR is triggered, receive the dedicated TA value of the first device or a difference between the first TA value and a second TA value, by using a first byte segment corresponding to the first TAR, where the second TA value is a TA value in a second TAR sent by the first device last time.

Optionally, a first byte segment corresponding to the first TAR is divided into at least two second byte segments, and one of the at least two second byte segments is used to send a dedicated TA value of the first device or a difference between a first TA value in the first TAR and a second TA value, the second TA value is a TA value in a second TAR sent by the first device last time.

Optionally, the first TAR is used to determine a first resource, and the second transceiver unit 1210 is further configured to receive or send first transmission on the first resource. The first resource is one of multiple resources related to half-duplex communication, the first transmission is determined according to a first priority order, the first priority order is one of multiple priority orders, the multiple priority orders are used for the multiple resources, and the first priority order is corresponding to the first resource.

Optionally, the second transceiver unit 1210 in the apparatus 1200 may be a transceiver 1530, and the apparatus 1200 may further include a processor 1510 and a memory 1520, which are specifically shown in FIG. 15.

FIG. 13 is a schematic block diagram of a wireless communication apparatus according to an embodiment of this application. The apparatus 1300 may be the first devices in any embodiment described above. The apparatus 1300 shown in FIG. 13 includes a third transceiver unit 1310.

The third transceiver unit 1310 may be configured to send or receive the first transmission on the first resource according to the first priority order. The first resource is one of multiple resources related to half-duplex communication, the first priority order is one of multiple priority orders, the multiple priority orders are used for the multiple resources, and the first priority order is corresponding to the first resource.

Optionally, the first transmission is one of multiple types of transmissions. The multiple types of transmissions include a first category of transmissions and a second category of transmissions other than the first category of transmissions. The first priority order includes that a priority of the first category of transmissions is higher than a priority of the second category of transmissions. The first category of transmissions includes one or more of the following: downlink transmission of a SIB; a TAR and/or an SR triggered by a TAR; transmission enabled/disabled with HARQ feedback; or uplink transmission based on DMRS bundling.

Optionally, the first category of transmissions further includes downlink transmission of SIB19, and the first priority order includes that a priority of downlink transmission of SIB19 is higher than a priority of transmission enabled/disabled with HARQ feedback, a priority of a TAR and/or an SR triggered by a TAR, and a priority of uplink transmission based on DMRS bundling.

Optionally, the first priority order includes that a priority of transmission enabled/disabled with HARQ feedback is higher than a priority of a TAR and/or an SR triggered by a TAR and a priority of uplink transmission based on DMRS bundling.

Optionally, the first priority order includes that a priority of a TAR and/or an SR triggered by a TAR is higher than a priority of uplink transmission based on DMRS bundling.

Optionally, the first resource is related to the first TAR sent by the first device, and the first TAR is triggered according to one or more of the following information: a TAR triggering indication sent by a higher layer, a TA offset threshold configured by a higher layer, a service serving time of the first device, or a service type of the first device.

Optionally, the first resource includes a resource corresponding to a guard time. When the guard time is corresponding to multiple types of transmissions, the apparatus 1300 further includes a determining unit, which may be configured to determine the first transmission from the multiple types of transmissions according to a first priority order. The multiple types of transmissions except the first transmission are performed on a resource after the guard time.

Optionally, the guard time is determined according to an elevation angle of the first device to the satellite in the NTN and/or a change value of the elevation angle in a first time period.

Optionally, the change value of the elevation angle in the first time period has multiple value ranges, and the multiple value ranges include a first value range and a second value range. The first value range is corresponding to a first guard time, and the second value range is corresponding to a second guard time. When a lower limit value of the first value range is greater than or equal to an upper limit value of the second value range, a length of the first guard time is greater than a length of the second guard time.

Optionally, a start time of the guard time is

$${T}_{TA}^{Report} - {Δ}_{TA} ,$$

and an end time of the guard time is

$${T}_{TA}^{Report} + {Δ}_{TA} , where , {T}_{TA}^{Report}$$

indicates a current TA value of the first device, and Δ_{TA} indicates a difference between a current TA value and a previous TA value.

Optionally, the multiple resources include multiple transmission windows of SIB19, the multiple transmission windows include a first transmission window and a second transmission window, a priority order corresponding to the first transmission window includes that downlink transmission of SIB19 has the highest priority, and a priority order corresponding to the second transmission window includes that downlink transmission of SIB19 has the lowest priority.

Optionally, the third transceiver unit 1310 in the apparatus 1300 may be a transceiver 1530, and the apparatus 1300 may further include a processor 1510 and a memory 1520, which are specifically shown in FIG. 15.

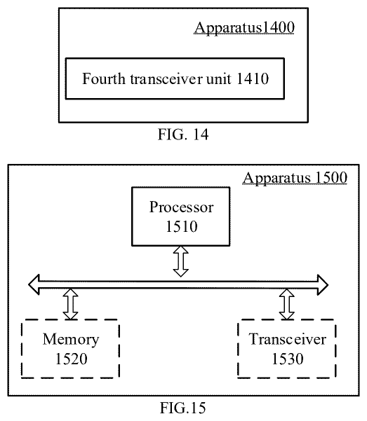

FIG. 14 is a schematic block diagram of another wireless communication apparatus according to an embodiment of this application. The apparatus 1400 may be the second device in any embodiment described above. The apparatus 1400 shown in FIG. 14 includes a fourth transceiver unit 1410.

The fourth receiving and transmitting unit 1410 may be configured to receive or send the first transmission on the first resource. The first resource is one of multiple resources related to half-duplex communication, the first transmission is determined according to a first priority order, the first priority order is one of multiple priority orders, the multiple priority orders are used for the multiple resources, and the first priority order is corresponding to the first resource.

Optionally, the first transmission is one of multiple types of transmissions. The multiple types of transmissions include a first category of transmissions and a second category of transmissions other than the first category of transmissions. The first priority order includes that a priority of the first category of transmissions is higher than a priority of the second category of transmissions. The first category of transmissions includes one or more of the following: downlink transmission of a SIB; a TAR and/or an SR triggered by a TAR; transmission enabled/disabled with HARQ feedback; or uplink transmission based on DMRS bundling.

Optionally, the first category of transmissions further includes downlink reception of SIB19, and the first priority order includes that a priority of downlink reception of SIB19 is higher than a priority of transmission enabled/disabled with HARQ feedback, a priority of a TAR and/or an SR triggered by a TAR, and a priority of uplink transmission based on DMRS bundling.

Optionally, the first priority order includes that a priority of transmission enabled/disabled with HARQ feedback is higher than a priority of a TAR and/or an SR triggered by a TAR and a priority of uplink transmission based on DMRS bundling.

Optionally, the first priority order includes a priority of a TAR and/or an SR triggered by a TAR is higher than a priority of uplink transmission based on DMRS bundling.

Optionally, the first resource is related to the first TAR sent by the first device, and the first TAR is triggered according to one or more of the following information: a TAR triggering indication sent by a higher layer, a TA offset threshold configured by a higher layer, a service serving time of the first device, or a service type of the first device.

Optionally, the first resource includes a resource corresponding to a guard time. When the guard time is corresponding to multiple types of transmissions, the first priority order is used to determine the first transmission from the multiple types of transmissions. The multiple types of transmissions except the first transmission are performed on a resource after the guard time.

Optionally, the guard time is determined according to an elevation angle of the first device to the satellite in the NTN and/or a change value of the elevation angle in a first time period.

Optionally, the change value of the elevation angle in the first time period has multiple value ranges, and the multiple value ranges include a first value range and a second value range. The first value range is corresponding to a first guard time, and the second value range is corresponding to a second guard time. When a lower limit value of the first value range is greater than or equal to an upper limit value of the second value range, a length of the first guard time is greater than a length of the second guard time.

Optionally, a start time of the guard time is

$${T}_{TA}^{Report} - {Δ}_{TA} ,$$

and an end time of the guard time is

$${T}_{TA}^{Report} + {Δ}_{TA} , where , {T}_{TA}^{Report}$$

indicates a current TA value of the first device, and Δ_{TA} indicates a difference between a current TA value and a previous TA value.

Optionally, the multiple resources include multiple transmission windows of SIB19, the multiple transmission windows include a first transmission window and a second transmission window, a priority order corresponding to the first transmission window includes that downlink transmission of SIB19 has the highest priority, and a priority order corresponding to the second transmission window includes that downlink transmission of SIB19 has the lowest priority.

Optionally, the fourth transceiver unit 1410 in the apparatus 1400 may be a transceiver 1530, and the apparatus 1400 may further include a processor 1510 and a memory 1520, which are specifically shown in FIG. 15.

FIG. 15 is a schematic structural diagram of a communications apparatus according to an embodiment of this application. A dashed line in FIG. 15 indicates that the unit or module is optional. The apparatus 1500 may be configured to implement the method described in the foregoing method embodiments. The apparatus 1500 may be a chip, a terminal device, or a network device.

The apparatus 1500 may include one or more processors 1510. The processor 1510 may support the apparatus 1500 to implement the method described in the foregoing method embodiments. The processor 1510 may be a general-purpose processor or a dedicated processor. For example, the processor may be a central processing unit (central processing unit, CPU). Alternatively, the processor may be another general-purpose processor, a digital signal processor (digital signal processor, DSP), an application-specific integrated circuit (application specific integrated circuit, ASIC), a field programmable gate array (field programmable gate array, FPGA) or another programmable logic device, a discrete gate or transistor logic device, a discrete hardware component, or the like. The general-purpose processor may be a microprocessor, or the processor may be any conventional processor or the like.

The apparatus 1500 may further include one or more memories 1520. The memory 1520 stores a program, and the program may be executed by the processor 1510, so that the processor 1510 executes the method described in the foregoing method embodiments. The memory 1520 may be independent of or integrated into the processor 1510.

The apparatus 1500 may further include a transceiver 1530. The processor 1510 may communicate with another device or chip by using the transceiver 1530. For example, the processor 1510 may perform data receiving and transmitting with another device or chip by using the transceiver 1530.

An embodiment of the present application further provides a computer-readable storage medium for storing a program. The computer-readable storage medium may be applied to the first device or the second device provided in embodiments of the present application, and the program causes a computer to perform the methods to be performed by the first device or the second device in various embodiments of the present application.

The computer-readable storage medium may be any usable medium readable by the computer, or a data storage device, such as a server or a data center, integrating one or more usable media. The usable medium may be a magnetic medium (for example, a floppy disk, a hard disk, or a magnetic tape), an optical medium (for example, a digital video disc (digital video disc, DVD)), a semiconductor medium (for example, a solid state disk (solid state disk, SSD)), or the like.

An embodiment of the present application further provides a computer program product. The computer program product includes a program. The computer program product may be applied to the first device or the second device provided in embodiments of the present application, and the program causes a computer to perform the methods to be performed by the first device or the second device in various embodiments of the present application.

All or some of the foregoing embodiments may be implemented by using software, hardware, firmware, or any combination thereof. When software is used to implement embodiments, the foregoing embodiments may be implemented completely or partially in a form of a computer program product. The computer program product includes one or more computer instructions. When the computer program instructions are loaded and executed on a computer, the procedures or functions according to embodiments of the present application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from one website, computer, server, or data center to another website, computer, server, or data center in a wired (for example, a coaxial cable, an optical fiber, and a digital subscriber line (digital subscriber line, DSL)) manner or a wireless (for example, infrared, wireless, and microwave) manner.

An embodiment of the present application further provides a computer program. The computer program may be applied to the first device or the second device provided in embodiments of the present application, and the computer program causes a computer to perform the methods to be performed by the first device or the second device in embodiments of the present application.

It should be understood that the terms “system” and “network” in the present application may be used interchangeably. In addition, the terms used in the present application are only used to explain the specific embodiments of the present application, and are not intended to limit the present application. The terms “first”, “second”, “third”, “fourth”, and the like in the specification, claims, and accompanying drawings of the present application are used to distinguish between different objects, rather than to describe a specific order. In addition, the terms “include” and “have” and any variations thereof are intended to cover a non-exclusive inclusion.

In embodiments of the present application, “indicate” mentioned herein may refer to a direct indication, or may refer to an indirect indication, or may mean that there is an association relationship. For example, A indicates B, which may mean that A directly indicates B, for example, B may be obtained by means of A; or may mean that A indirectly indicates B, for example, A indicates C, and B may be obtained by means of C; or may mean that there is an association relationship between A and B.

In embodiments of the present application, the term “correspond” may mean that there is a direct or indirect correspondence between the two, or may mean that there is an association relationship between the two, or may mean that there is a relationship such as indicating and being indicated, or configuring and being configured.

In embodiments of the present application, “predefined” or “pre-configured” may be implemented by pre-storing corresponding code, tables, or other forms that may be used to indicate related information in devices (for example, including a terminal device and a network device), and a specific implementation thereof is not limited in the present application. For example, being predefined may refer to being defined in a protocol.

In embodiments of the present application, the “protocol” may refer to a standard protocol in the communications field, and may include, for example, an LTE protocol, an NR protocol, and a related protocol applied to a future communications system, which is not limited in the present application.

In embodiments of the application, determining B according to A does not mean determining B according to A only, and may further determine B according to A and/or other information.

In embodiments of the present application, the term “and/or” is merely an association relationship that describes associated objects, and represents that there may be three relationships. For example, A and/or B may represent three cases: only A exists, both A and B exist, and only B exists. In addition, the character “/” in this specification generally indicates an “or” relationship between the associated objects.

In embodiments of the present application, sequence numbers of the foregoing processes do not mean execution sequences. The execution sequences of the processes should be determined according to functions and internal logic of the processes, and should not be construed as any limitation on the implementation processes of embodiments of the present application.

In several embodiments provided in the present application, it should be understood that the disclosed system, apparatus, and method may be implemented in other manners. For example, the described apparatus embodiments are merely examples. For example, unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

Units described as separate components may be or may not be physically separate, and components displayed as units may be or may not be physical units, that is, may be located in one position, or distributed on a plurality of network units. Some or all of the units may be selected according to actual needs to achieve the objectives of solutions in embodiments.

In addition, functional units in embodiments of the present application may be integrated into one processing unit, or each of the units may exist alone physically, or two or more units may be integrated into one unit.

The foregoing descriptions are merely specific implementations of this application, but the protection scope of this application is not limited thereto. Any variation or replacement readily figured out by persons skilled in the art within the technical scope disclosed in this application shall fall within the protection scope of this application. Therefore, the protection scope of this application shall be subject to the protection scope of the claims.

What is claimed is:

1. A wireless communication method, comprising:
sending, by a first reduced capability (RedCap) device in a non-terrestrial network (NTN), a first timing advance report (TAR) according to first information, wherein the first information comprises at least one of a service serving time of the first RedCap device or a service type of the first RedCap device.

2. The method according to claim 1, wherein the first information further comprises one or more of:
a TAR triggering indication sent by a higher layer; or
a timing advance (TA) offset threshold configured by a higher layer.

3. The method according to claim 2, wherein the method further comprises:
sending, by the first RedCap device, the first TAR when the first RedCap device receives the TAR triggering indication and the service serving time of the first RedCap device is greater than a first threshold; or
skipping, by the first RedCap device, sending of the first TAR when the service serving time of the first RedCap device is equal to or less than the first threshold.

4. The method according to claim 3, wherein the first RedCap device corresponds to a serving cell of the NTN, and the first threshold is determined according to a serving time of a satellite corresponding to the serving cell.

5. The method according to claim 1, wherein the first RedCap device corresponds to a serving cell of the NTN, and a service serving time of the first RedCap device is determined according to at least one of a location of the first RedCap device or a serving time of a satellite corresponding to the serving cell.

6. The method according to claim 1, wherein the service type of the first RedCap device is related to a TA offset threshold, and the method further comprises:
setting, by the first RedCap device, a first timer related to the TA offset threshold according to the service type.

7. The method according to claim 1, wherein a first TA value in the first TAR is determined according to a TA value in a TA command, a first offset value, a common TA, and a dedicated TA value of the first RedCap device, and the method further comprises:
sending, by the first RedCap device when the first TAR is triggered, the dedicated TA value of the first RedCap device or a difference between the first TA value and a second TA value, by using a first byte segment corresponding to the first TAR, wherein the second TA value is a TA value in a second TAR sent by the first RedCap device last time.

8. The method according to claim 1, wherein a first byte segment corresponding to the first TAR is divided into at least two second byte segments, and one of the at least two second byte segments is used to send a dedicated TA value of the first RedCap device or a difference between a first TA value in the first TAR and a second TA value, the second TA value is a TA value in a second TAR sent by the first RedCap device last time.

9. The method according to claim 1, wherein the first TAR is used to determine a first resource, and the method further comprises:
sending or receiving, by the first RedCap device, first transmission on the first resource according to a first priority order,
wherein the first resource is one of a plurality of resources related to half-duplex communication, the first priority order is one of a plurality of priority orders, the plurality of priority orders are used for the plurality of resources, and the first priority order is corresponding to the first resource.

10. A wireless communication method, comprising:
receiving, by a second device in a non-terrestrial network (NTN), a first timing advance report TAR from a first reduced capability (RedCap) device,
wherein the first TAR is triggered according to first information, the first information comprises at least one of a service serving time of the first RedCap device or a service type of the first RedCap device.

11. The method according to claim 10, wherein the first information further comprises one or more of:
a TAR triggering indication sent by a higher layer; or
a timing advance (TA) offset threshold configured by a higher layer.

12. A first reduced capability (RedCap) device, comprising:
at least one processor; and
one or more non-transitory computer-readable storage media coupled to the at least one processor and storing programming instructions for execution by the at least one processor, wherein the programming instructions, when executed, cause the first RedCap device to perform operations comprising:
sending, to a second device in a non-terrestrial network (NTN), a first timing advance report (TAR) according to first information, wherein the first information comprises at least one of a service serving time of the first RedCap device or a service type of the first RedCap device.

13. The first RedCap device according to claim 12, wherein the first information further comprises one or more of:
a TAR triggering indication sent by a higher layer; or
a timing advance (TA) offset threshold configured by a higher layer.

14. The first RedCap device according to claim 13, wherein the operations comprise:
sending the first TAR when the first RedCap device receives the TAR triggering indication and the service serving time of the first RedCap device is greater than a first threshold; or
skipping, by the first RedCap device, sending of the first TAR when the service serving time of the first RedCap device is equal to or less than the first threshold.

15. The first RedCap device according to claim 14, wherein the first RedCap device corresponds to a serving cell of the NTN, and the first threshold is determined according to a serving time of a satellite corresponding to the serving cell.

16. The first RedCap device according to claim 12, wherein the first RedCap device corresponds to a serving cell of the NTN, and a service serving time of the first RedCap device is determined according to at least one of a location of the first RedCap device or a serving time of a satellite corresponding to the serving cell.

17. The first RedCap device according to claim 12, wherein the service type of the first RedCap device is related to a TA offset threshold, and the operations further comprise:
setting a first timer related to the TA offset threshold according to the service type.

18. The first RedCap device according to claim 12, wherein a first TA value in the first TAR is determined according to a TA value in a TA command, a first offset value, a common TA, and a dedicated TA value of the first RedCap device, and the operations further comprise:
when the first TAR is triggered, setting the dedicated TA value of the first RedCap device or a difference between the first TA value and a second TA value, by using a first byte segment corresponding to the first TAR, wherein the second TA value is a TA value in a second TAR sent by the first RedCap device last time.

19. The first RedCap device according to claim 12, wherein a first byte segment corresponding to the first TAR is divided into at least two second byte segments, and one of the at least two second byte segments is used to send a dedicated TA value of the first RedCap device or a difference between a first TA value in the first TAR and a second TA value, the second TA value is a TA value in a second TAR sent by the first RedCap device last time.

20. The first RedCap device according to claim 12, wherein the first TAR is used to determine a first resource, and the operations further comprise:
sending or receiving first transmission on the first resource according to a first priority order,
wherein the first resource is one of a plurality of resources related to half-duplex communication, the first priority order is one of a plurality of priority orders, the plurality of priority orders are used for the plurality of resources, and the first priority order is corresponding to the first resource.
